(19) United States
(12) Patent Application Publication
(10) Pub. No.: US 2013/0160268 A1
(43) Pub. Date: Jun. 27, 2013

(54) QUICK COUPLER

(71) Applicants: Jeffrey Parker, Fuquay-Varina, NC (US); H. Patrick Gaines, Cary, NC (US)

(72) Inventors: Jeffrey Parker, Fuquay-Varina, NC (US); H. Patrick Gaines, Cary, NC (US)

(73) Assignee: Caterpillar Inc., Peoria, IL (US)

(21) Appl. No.: 13/334,298

(22) Filed: Dec. 22, 2011

(51) Int. Cl. F16B 21/00; B23P 17/04

(52) U.S. Cl. 29/428; 403/321

(57) ABSTRACT

A quick coupler for connecting an implement to a machine, the implement having a connection pin, the quick coupler, including a frame, includes a jaw pivotally connected to the frame and movable between an open position and a closed position, the jaw configured to cooperate with the connection pin of the implement. The quick coupler also including a lock pivotally connected to the frame and movable between an unlocked position and a locked position, the lock including a pawl configured to cooperate with a detent on the jaw. The quick coupler including a release mechanism connected to the frame and to the lock, wherein the jaw in the closed position and the lock in the locked position define a load path, the release mechanism being positioned outside the load path.

### TECHNICAL FIELD

The present disclosure relates to a coupler for connecting an implement to a machine. In particular, the present disclosure relates to a quick coupler for connecting and disconnecting a tool, such as a bucket or shovel, to a machine such as a backhoe, excavator, or similar machine.

### BACKGROUND

A quick coupler is fixed to an arm of a machine for connecting and disconnecting implements to the arm. For example, a quick coupler can be attached to the arm of a machine such as a backhoe or an excavator to connect and disconnect the arm and implements such as buckets, hammers, rippers, and grapples. Such quick couplers are advantageous because they allow a machine operator to change quickly from one implement to another. Thus, the use of a quick coupler makes the machine more efficient and versatile.

Several different types of quick couplers have been employed in the past. One exemplary quick coupler is disclosed in international patent application publication number WO2011/033253, which discloses a fully automatic coupler for an excavator arm. The coupler disclosed in WO2011/033253 includes a pair of jaws configured to receive corresponding pins on an implement. Each of the jaws is coupled to a corresponding latch mechanism. The first latching mechanism is configured to move to a closed or latched position when the coupler is in its normal configuration, and move to an open or unlatched position when the coupler is inverted. The second latch mechanism is connected to a hydraulic actuator configured to open and close the second jaw.

One shortcoming of having a hydraulic actuator controlling a jaw of the coupler is that should the actuator fail, the jaw could then open unexpectedly, causing the implement pins to become disconnected from the coupler. The present disclosure presents a quick coupler including jaws biased towards an open position and a lock biased towards a locked position. The power link of the machine may be used to overcome the open bias of the jaws, thereby moving the jaws from an open position to a closed position. In the closed position, the lock, being biased towards the locked position, moves to engage the jaws, thereby retaining the jaws in the closed position. An actuator may be provided to disengage the lock from the jaws, thereby allowing the jaws to open. However, because the actuator is outside of the load path between the implement and the quick coupler structure, the likelihood of disengagement is reduced over prior designs.

### SUMMARY OF THE INVENTION

One aspect of the present disclosure includes a quick coupler for connecting an implement to a machine. The implement includes a connection pin. The quick coupler including a frame and includes a jaw pivotally connected to the frame and movable between an open position and a closed position. The jaw may be configured to cooperate with the connection pin of the implement. The quick coupler further includes a lock pivotally connected to the frame and movable between an unlocked position and a locked position. The lock including a pawl configured to cooperate with a detent on the jaw. The quick coupler further including a release mechanism connected to the frame and to the lock, wherein the jaw in the closed position and the lock in the locked position define a load path, the release mechanism being positioned outside the load path.

Another aspect of the present disclosure includes A quick coupler for connecting an implement to a machine, the implement having a pair of spaced apart connection pins, the quick coupler including a frame and having a first jaw and a second jaw pivotally connected to the frame, each of the first jaw and the second jaw movable between an open position and a closed position. The quick coupler may also include a lock mechanism, the lock mechanism having a first lock member and a second lock member. The first lock member and the second lock member may be pivotally connected to the frame. The first lock member may be positioned proximate to the first jaw and include a first pawl configured to cooperate with a first detent on the first jaw. Likewise, the second lock member may be positioned proximate to the second jaw and include a second pawl configured to cooperate with a second detent on the second jaw. The lock mechanism may also include a connecting link pivotally connected to the first lock member and to the second lock member. The lock mechanism may further include a release mechanism configured for cooperation with the lock mechanism. The quick coupler may be configured such that when the first jaw and the second jaw are in the closed position and the first lock member and the second lock member are in the locked position, the first jaw and the first lock member define a first load path, the second jaw and the second lock member define a second load path, and the release mechanism is positioned outside of the first load path and the second load path.

Another aspect of the present disclosure includes a method for connecting a machine to an implement having a pair of spaced apart connection pins. The method includes the steps of providing a quick coupler attached to the machine. The quick coupler may include a first jaw and a second jaw operable between an open position and a closed position, and a lock mechanism configured to cooperate with the first jaw and the second jaw. The first jaw and the second jaw are configured in the open position. The quick coupler may be positioned so that the first jaw and the second jaw are each located proximately to one of the connection pins. A downward force on the quick coupler is provided by the machine, wherein the downward force moves the first jaw and the second jaw to the closed position about the connecting pins. The locking mechanism is engaged with the first jaw and the second jaw thereby maintaining the first jaw and the second jaw in the closed position.

### BRIEF DESCRIPTION OF THE DRAWINGS

FIG. 1 is a sectional side view of an embodiment of a quick coupler of the present disclosure.

FIG. 2 is a top perspective view of the quick coupler of FIG. 1.

FIG. 3 is a sectional side view of an embodiment of a quick coupler of the present disclosure including a release actuator.

### DETAILED DESCRIPTION

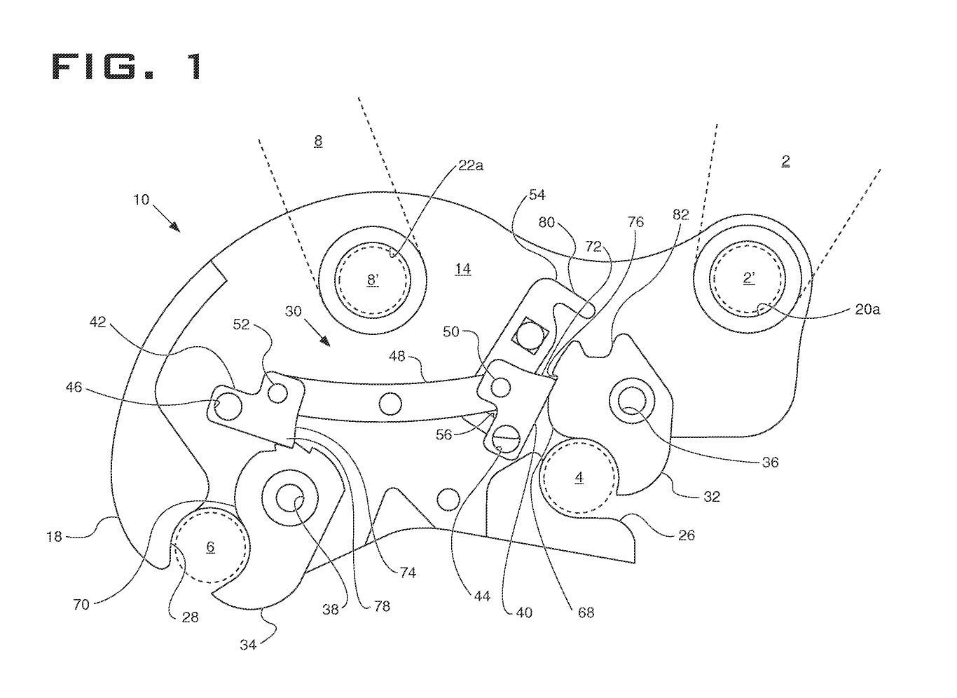

Referring to FIG. 1, a quick coupler is disclosed for connecting an implement (not shown) to a support arm or a stick 2 of a machine such as a backhoe or an excavator (not shown). The implement may be of any kind known in the art, including, but not limited to, a bucket, a shovel, a hammer, a saw, mechanical shears, and the like. The implement may include pins 4, 6 attached to the implement, spaced apart, and oriented in a generally horizontal configuration when the implement is resting on the ground. For example, pins 4, 6 may be supported by and span between spaced apart brackets on the implement in a generally parallel configuration.

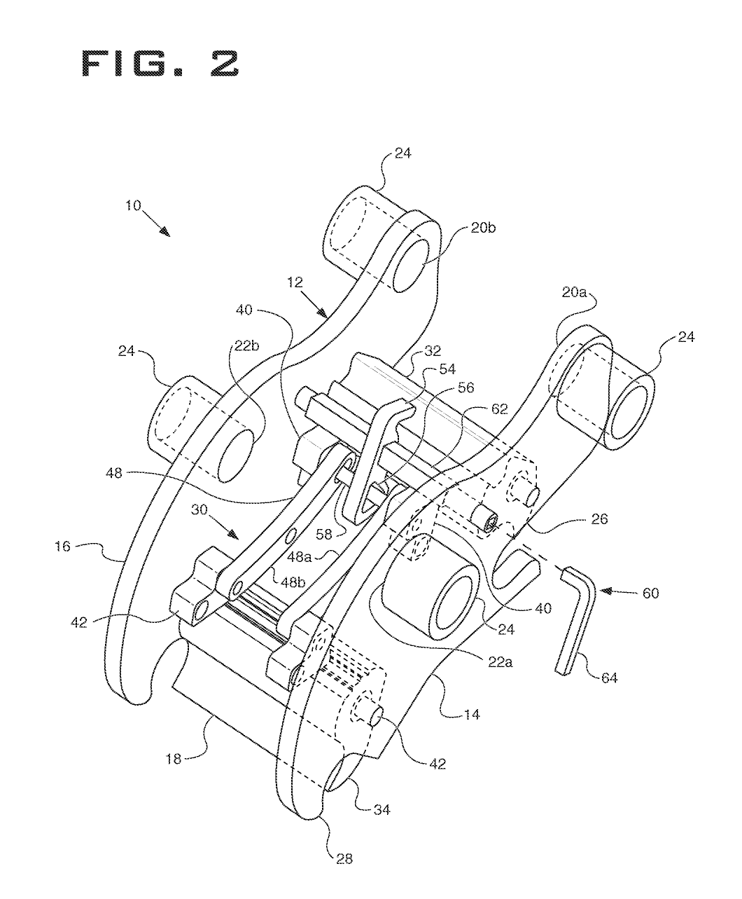

Referring to FIGS. 1 and 2, the quick coupler 10 may include a frame 12. The frame 12 may include a first side plate 14, a second side plate 16, and a cross plate 18. The frame 12 may further include two sets of aligned pin openings 20a, 20b and 22a, 22b in the first side plate 14 and the second side plate 16. As shown in FIG. 1, aligned pin openings 20a, 20b may be configured to receive a pin 2′ attached to the stick 2 of the machine. Likewise, aligned pin openings 22a, 22b may be configured to receive a pin 8′ attached to the power link 8. A collar 24 may be disposed about each of the aligned pin openings 20a, 20b and 22a, 22b on an outer surface of first side plate 14 and second side plate 16. Thus, the stick 2 and the power link 8 may be operably connected to quick coupler 10 about pins 2′ and 8′.

Recesses 26, 28 may be provided in the frame 12 configured to engage implement pins 4, 6, respectively. In the exemplary embodiment, recesses 26, 28 may be positioned at a lower portion of the frame 12 while the stick 2 and power link 8 may be attached to the top of the frame 12, as shown in FIG. 1.

Quick coupler 10 may further include a locking system 30 disposed within the frame 12 between the first side plate 14 and the second side plate 16. Locking system 30 may include a first jaw 32 configured to retain first implement pin 4, and a second jaw 34 configured to retain second implement pin 6. First jaw 32 and second jaw 34 may be pivotally connected to the frame 12 by first jaw pivot 36 and second jaw pivot 38, respectively. First jaw pivot 36 may be configured as a pin attached to the frame 12 between the first side plate 14 and the second side plate 16 proximate to the first recess 26, allowing the first jaw 32 to rotate freely about the first jaw pivot 36. Similarly second jaw pivot 38 may be configured as a pin attached to the frame 12 between the first side plate 14 and the second side plate 16 proximate to the second recess 28, allowing the second jaw 34 to rotate freely about the second jaw pivot 38. First jaw 32 and second jaw 34 may be biased, such as by a spring (not shown), toward an open position, which would allow recesses 26, 28 to receive implement pins 4, 6.

The locking system 30 may further include a first lock member 40 configured to cooperate with the first jaw 32, and a second lock member 42 configured to cooperate with the second jaw 34. The first lock member 40 may be pivotally connected to the frame 12 at a first lock pivot 44. The second lock member 42 may be pivotally connected to the frame 12 at a second lock pivot 46. The first lock member 40 and the second lock member 42 may be biased, such as by a spring (not shown), towards a closed or locked position.

In use, forces and loads acting on the implement are transmitted through the first pin 4, to the first jaw 32, to the first lock member 40, to the frame 12. The first jaw 32 and the first lock member 40 define a first load path between the implement and the frame 12 of the quick coupler 10. Similarly, the second jaw 34 and the second lock member 42 define a second load path between the implement and the frame 12, whereby forces and loads are transmitted to the second jaw 43, to the second lock member 42, and to the frame 12.

A connecting link 48 may be disposed between and pivotally connected to each of the first lock member 40 and second lock member 42. The connecting link 48 may be attached to the first lock mechanism 44 at a first link pivot 50, and attached to the second lock member 42 at a second link pivot 52.

A latch 54 may be provided to cooperate with the connecting link 48 to retain the first and second lock members 40, 42 in an open or unlocked position. As best viewed in FIG. 2, latch 54 may include an aperture 56 configured for cooperation with connecting link 48. In the exemplary embodiment, the connecting link 48 may include a pair of substantially parallel bars 48a, 48b and a connecting link cross member 58 disposed at one end of the connecting link 48. The cross member 58 may be configured to pass through the aperture 56 of latch 54. The aperture 56 may be configured to allow some slack between latch 54 and cross member 58.

Referring to FIG. 2, an embodiment of the quick coupler of the present disclosure may include a release mechanism 60 for disengaging the quick coupler 10 from implement pins 4, 6. Release mechanism 60 may include a release link 62 configured to cooperate with latch 54. In the exemplary embodiment shown in FIG. 2, the release mechanism 60 may be configured for manual operation and may include a release handle 64 configured to allow an operator to move the release link 62, thereby disengaging the quick coupler 10 as described below. In addition to the release handle 64, it is envisioned that the release mechanism 60 may be configured to engage a ratchet, breaker bar, wrench, or similar tool, for operation.

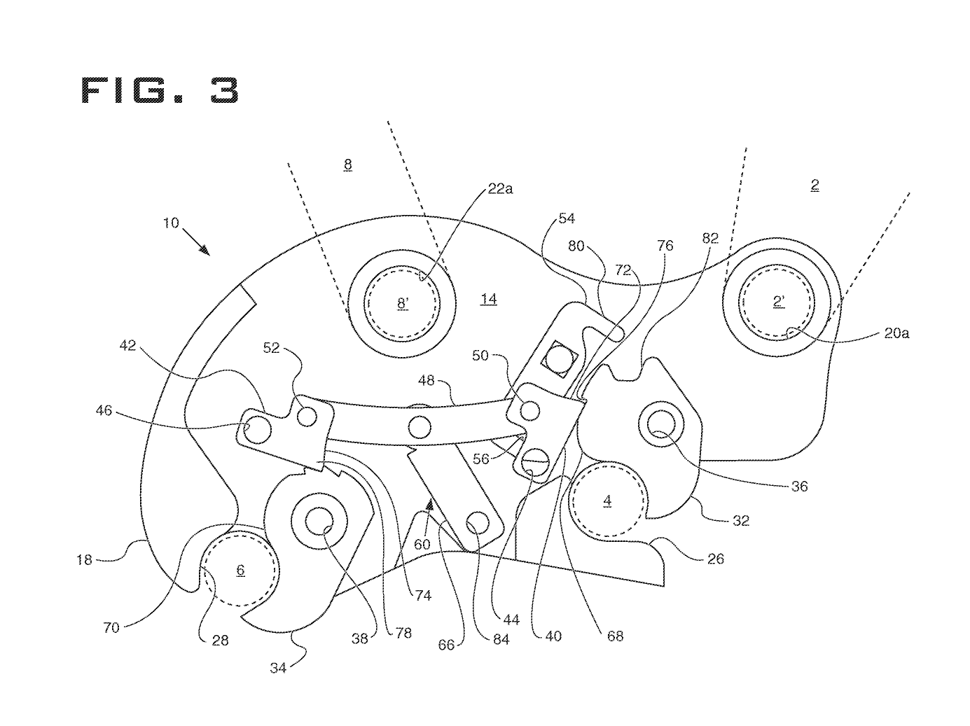

In another embodiment of the present disclosure, the release mechanism 60 may be configured for automatic operation. Referring to FIG. 3, release mechanism may include a release actuator 66. Release actuator 66 may be pivotally connected to the quick coupler 10 between the first side plate 14 and the second side plate 16. Release actuator 66 may also be pivotally connected to the connecting link 48. In the exemplary embodiment, the release actuator 66 may be configured as a hydraulic piston and cylinder. However, as should be apparent, any satisfactory actuator such as a solenoid, linear motor, etc. may be equally acceptable. Release actuator 66 also may be configured for connection to a hydraulic system, or other power system, on the machine.

The release link 62 and the release actuator 66 are positioned to be outside the load paths defined by the first jaw 32 and the first lock member 40 and by the second jaw 34 and the second lock member 42. Because the release link 62 and release actuator 66 are outside the load paths, they need not be sized to withstand the load generated by the implement during use.

### INDUSTRIAL APPLICABILITY

The present disclosure is applicable to machines, such as backhoes, excavators, and similar machines that may be used to perform multiple functions. For example, a backhoe or an excavator may be used for excavation or digging in soil, rock, or other material. For such digging operations, the machine typically may use a bucket or shovel, however, different types of buckets may be required for different materials. Additionally, a machine may be used to perform different tasks, for which other implements may need to be attached to the machine. Such other implements may include, for example, hammers, grapples, and similar tools.

In operation, the quick coupler 10 may be first attached to the arm or stick 2 of a machine by a pin 2′ which may be inserted through aligned pin openings 20a, 20b formed in the first and second side plates 14, 16. The quick coupler may also be attached to the power link 8 of the machine by a pin 8′ which may be inserted through aligned pin openings 22a, 22b formed in the first and second side plates 14, 16.

To attach an implement to the quick coupler 10, an operator maneuvers the stick 2 to position the quick coupler 10 over the implement. The quick coupler 10 is configured such that first and second jaws 32, 34 are each biased to an open position allowing access to first and second recesses 26, 28. The quick coupler 10 may be moved onto the implement so that pin 4 is received into recess 26 and pin 6 is received into recess 28. At this point, a hydraulic actuator connected to power link 8 may be extended, thereby exerting a downward force driving the quick coupler 10 against pins 4 and 6.

The force exerted on the quick coupler 10 by the power link 8 acts upon a first cam 68 on the first jaw 32 and upon a second cam 70 on the second jaw 34. Pins 4 and 6 act against the first and second cams 68 and 70, respectively, causing jaws 32 and 34 to rotate about pivots 36,38, thereby overcoming the bias of jaws 32, 34 closing the jaws against pins 4, 6.

The first lock member 40 and the second lock member 42, being biased in a closed direction, rotate about first and second lock pivots 44, 46, respectively. First lock member 40 includes a first pawl 72 and the second lock member 42 includes a second pawl 74. The first pawl 72 may be configured to engage a first detent 76 on first jaw 32 and the second pawl 74 may be configured to engage a second detent 78 on second jaw 34. The bias of the first and second lock members 40, 42 secures together first and second pawls 72, 74 and first and second detents 76, 78 thereby locking the first and second jaws 32, 34 in a closed position about pins 4, 6.

In an embodiment of the present disclosure, the jaws 32, 34 may be released from the closed position by manually disengaging the first and second lock members 40, 42 from the first and second jaws 32, 34. In this exemplary embodiment, an operator must attach a tool, such as release handle 64 to manipulate the release link 62. The release link 64 is rotated such that an inside surface of the aperture 56 in latch 54 engages the connecting link 48 pivot rod 50 in an upward direction. Upward movement of connecting link 48 causes first and second lock members 40, 42 to rotate about pivots 44, 46 towards the open direction against the bias in the closed direction. Pawls 72, 74 disengage detents 76, 78 thereby allowing the bias of the jaws 32, 34 to rotate the jaws 32, 34 about pivots 36, 38 into an open position. Further, rotation of the release handle 64 by the operator rotates latch 54. Latch 54 may include a tongue 80 configured to cooperate with a groove 82 in the first jaw 32 so as to retain the first and second lock members 40, 42 and the connecting link 48 in an open position against the bias of the lock members 40, 42 towards the closed position.

In another embodiment of the present disclosure, a release actuator 66 may be provided to release the jaws 32, 34 from the closed position automatically without an operator having to manually disengage the first and second lock members 40, 42 from the first and second jaws 32, 34. In this exemplary embodiment, an actuator 66 is provided to release the quick coupler 10. The actuator 66 may be pivotally connected to the frame 12 at actuator pivot 84, and pivotally connected to the connecting link 48 at pivot 86.

The actuator 66 may be configured so that upon receiving a command from an operator, the actuator 66 provides a force against the connecting link 48 causing the connecting link to move in an upward direction. Upward movement of connecting link 48 causes first and second lock members 40, 42 to rotate about pivots 44, 46 in the open direction against the bias in the closed direction. Pawls 72, 74 disengage detents 76, 78 thereby allowing the bias of the jaws 32, 34 to rotate the jaws 32, 34 about pivots 36, 38 into an open position. Further, the upward movement of the connecting link 48 causes the connecting link cross member 58 to engage an inner surface of aperture 56 in latch 54, causing latch 54 to rotate such that tongue 80 cooperates with groove 82 in the first jaw so as to retain the first and second lock members 40, 42 and the connecting link 48 in an open position against the bias of the lock members 40, 42 towards the closed position.

It will be apparent to those skilled in the art that various modifications can be made to the disclosed quick coupler without departing from the scope of the invention. Other embodiments of the quick coupler will be apparent to those skilled in the art from consideration of the specification and the practice of the quick coupler disclosed herein. For example, although the disclosed quick coupler has been described as including a manual release feature and an automatic release feature, nevertheless, it is contemplated that a similar quick coupler may include both manual and automatic release features. It is intended that the specification and examples be considered exemplary only, with a true scope being indicated by the following claims and their equivalents.

What is claimed is:

1. A quick coupler for connecting an implement to a machine, the implement having a connection pin, the quick coupler includes a frame and comprises:
a jaw pivotally connected to the frame and movable between an open position and a closed position, the jaw configured to cooperate with the connection pin of the implement;
a lock pivotally connected to the frame and movable between an unlocked position and a locked position, the lock including a pawl configured to cooperate with a detent on the jaw; and
a release mechanism connected to the frame and to the lock, wherein the jaw in the closed position and the lock in the locked position define a load path between the implement and the frame, the release mechanism being positioned outside the load path.

2. The quick coupler of claim 1 wherein the jaw is configured to be biased towards the open position and the lock is configured to be biased towards the closed position.

3. The quick coupler of claim 1 further comprising a latch pivotally connected to the lock and movable between a latched position and an unlatched position, the latch including a tongue configured to cooperate with a groove on the jaw, wherein when the jaw is in the open position the latch is in the latched position, wherein the tongue engages the groove maintaining the lock in the unlocked position.

4. The quick coupler of claim 1 wherein the release mechanism comprises an actuator connected to the lock, the actuator configured to selectively provide a force to the lock, thereby disengaging the lock from the jaw.

5. The quick coupler of claim 4 wherein the actuator is configured to include a hydraulic piston and cylinder.

6. The quick coupler of claim 5 wherein the actuator is configured for connection to a hydraulic system on the machine.

7. The quick coupler of claim 1 wherein the release mechanism is configured to receive a detachable handle for manual operation.

8. A quick coupler for connecting an implement to a machine, the implement having first and second spaced-apart connection pins, the quick coupler includes a frame and comprises:
a first jaw and a second jaw pivotally connected to the frame, each of the first jaw and the second jaw movable between an open position and a closed position, the first jaw configured to cooperate with the first connection pin and the second jaw configured to cooperate with the second connection pin;
a lock mechanism, the lock mechanism comprising
a first lock member and a second lock member, the first lock member and the second lock member being pivotally connected to the frame and movable between an unlocked position and a locked position, the first lock member being positioned proximate to the first jaw and including a first pawl configured to cooperate with a first detent on the first jaw, the second lock member positioned proximate to the second jaw and including a second pawl configured to cooperate with a second detent on the second jaw, and
a connecting link pivotally connected to the first lock member and to the second lock member; and
a release mechanism configured for cooperation with the lock mechanism,
wherein when the first jaw and the second jaw are in the closed position and the first lock member and the second lock member are in the locked position, the first jaw and the first lock member define a first load path between the implement and the frame, the second jaw and the second lock member define a second load path between the implement and the frame, and wherein the release mechanism is positioned outside of the first load path and the second load path.

9. The quick coupler of claim 8 further including a latch having a tongue configured to cooperate with a groove disposed on one of the first jaw and the second jaw.

10. The quick coupler of claim 8 wherein the release mechanism includes a release link configured to allow manual disengagement of the lock mechanism from the first jaw and the second jaw.

11. The quick coupler of claim 8 wherein the release mechanism includes an actuator connected to the frame and to the connecting link, the actuator configured to impart an upward force on the connecting link.

12. The quick coupler of claim 11 wherein the actuator is configured as a hydraulic piston and cylinder.

13. The quick coupler of claim 12 wherein the actuator is configured for connection to a hydraulic system on the machine.

14. The quick coupler of claim 8 wherein the release mechanism is configured to receive a detachable handle for manual operation.

15. A method for connecting an implement to a machine, the implement having a pair of spaced-apart connection pins, the method comprising:
providing a quick coupler attached to the machine, the quick coupler comprising a frame, a first jaw and a second jaw operable between an open position and a closed position, and a lock mechanism configured to cooperate with the first jaw and the second jaw, wherein the first jaw and the second jaw are in the open position;
positioning the quick coupler so that the first jaw and the second jaw are each located proximately to one of the connection pins;
providing a downward force on the quick coupler by the machine, wherein the downward force moves the first jaw and the second jaw to the closed position about the connection pins;
engaging the lock mechanism with the first jaw and the second jaw thereby maintaining the first jaw and the second jaw in the closed position.

16. The method of claim 15 further comprising providing a release mechanism configured to selectively disengage the lock mechanism.

17. The method of claim 16 wherein the release mechanism is positioned outside of a load path between the implement and the frame of the quick coupler.

18. The method of claim 17 further including providing an actuator configured to cooperate with the release mechanism.

19. The method of claim 18 wherein the actuator is configured as a hydraulic piston and cylinder.

20. The method of claim 19 further comprising connecting the actuator to a hydraulic system of the machine.
